(19) United States
(12) Patent Application Publication
(10) Pub. No.: US 2021/0208369 A1
(43) Pub. Date: Jul. 8, 2021

(54) OPTICAL LENS

(71) Applicant: HON HAI PRECISION INDUSTRY CO., LTD., New Taipei (TW)

(72) Inventors: GWO-YAN HUANG, New Taipei (TW); MING-CHE SUNG, New Taipei (TW); HSING-CHEN LIU, New Taipei (TW)

(21) Appl. No.: 17/073,750

(22) Filed: Oct. 19, 2020

(30) Foreign Application Priority Data
Jan. 8, 2020 (CN) 202010016464.7

(51) Int. Cl. G02B 13/00; G02B 9/60

(52) U.S. Cl. CPC G02B 13/0045; G02B 9/60

(57) ABSTRACT

An optical lens includes an aperture, a first lens including a first surface and a second surface, a second lens including a third surface and a fourth surface, a third lens including a fifth surface and a sixth surface, a fourth lens including a seventh surface and a eighth surface, a fifth lens including a ninth surface and a tenth surface, and an image plane, arranged in that sequence, and satisfies the following conditions: −5.0≤(R3+R4)/(R3−R4)≤−0.75; −5.0≤(R5+R6)/(R5−R6)≤−0.8; −5.3≤R7/R8≤7; and 2≤(T2+T3)/T4≤4. R3, R4, R5, R6, R7, and R8 denote radius of curvatures of the third surface, the fourth surface, the fifth surface, the sixth surface, the seventh surface, and the eighth surface, respectively. T2, T3 and T4 denote distances from the image plane to the fourth surface, the sixth surface, and the eighth surface along the optical axis, respectively.

### FIELD

The subject matter herein generally relates to a lens, and more particularly, to an optical lens.

### BACKGROUND

In a field of photography, a camera lens is used to capture images. In order to get a more compact optical system, the size of optical lens should be smaller.

### BRIEF DESCRIPTION OF THE DRAWINGS

Implementations of the present technology will now be described, by way of example only, with reference to the attached figures.

FIG. 1 is a diagram of a first embodiment of an optical lens.

FIG. 2 is a field curvature diagram of the optical lens of FIG. 1.

FIG. 3 is a distortion diagram of the optical lens of FIG. 1.

FIG. 4 is an optical-modulation transfer function diagram of the optical lens of FIG. 1.

FIG. 5 is a diagram of a second embodiment of an optical lens.

FIG. 6 is a field curvature diagram of the optical lens of FIG. 5.

FIG. 7 is a distortion diagram of the optical lens of FIG. 5.

FIG. 8 is an optical-modulation transfer function diagram of the optical lens of FIG. 5.

FIG. 9 is a diagram of a third embodiment of an optical lens.

FIG. 10 is a field curvature diagram of the optical lens of FIG. 9.

FIG. 11 is a distortion diagram of the optical lens of FIG. 9.

FIG. 12 is an optical-modulation transfer function diagram of the optical lens of FIG. 9.

FIG. 13 is a diagram of a fourth embodiment of an optical lens.

FIG. 14 is a field curvature diagram of the optical lens of FIG. 13.

FIG. 15 is a distortion diagram of the optical lens of FIG. 13.

FIG. 16 is an optical-modulation transfer function diagram of the optical lens of FIG. 13.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better. The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising” when utilized, means “including, but not necessarily limited to”; it specifically indicates open-ended inclusion or membership in the so-described combination, group, series, and the like.

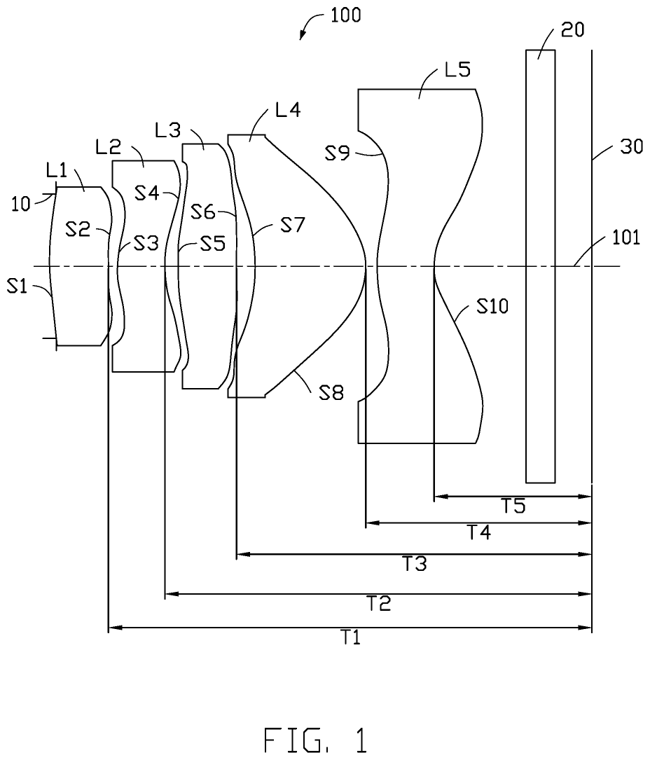

FIG. 1 illustrates an embodiment of an optical lens 100. The optical lens 100 can be applied in a safety system or an electronic device, such as mobile phone, personal computer, game machine, or camera.

The optical lens 100 comprises an aperture 10, a first lens L1, a second lens L2, a third lens L3, a fourth lens L4, a fifth lens L5, an optical filter 20, and an image plane 30, arranged in that sequence from object-side to image-side, along an optical axis 101 of the optical lens 100. Each of the aperture 10, the first lens L1, the second lens L2, the third lens L3, the fourth lens L4, the fifth lens L5, the optical filter 20, and the image plane 30 is symmetric around the optical axis 101.

In at least one embodiment, the first lens L1 has a positive refractive power to provide a main refractive power of the optical lens 100 and help shorten a total optical length of the optical lens 100. The second lens L2 has a negative refractive power to correct an optical aberration generated by the first lens L1 and correct a chromatic aberration of the optical lens 100. The third lens L3 has a negative refractive power to correct an optical aberration generated by the second lens L2, and correct a chromatic aberration of the optical lens 100 to reduce a sensitivity of the optical lens 100.

In at least one embodiment, the fourth lens L4 has a positive refractive power, and the fifth lens L5 has a negative refractive power. In this way, a telephoto structure with one positive refractive power lens and one negative refractive power lens is formed to help shorten a back focal length of the optical lens 100, thereby reducing the total optical length of the optical lens 100.

The first lens L1 comprises a first surface S1 and a second surface S2 facing away from the first surface S1. The second lens L2 comprises a third surface S3 and a fourth surface S4 facing away from the third surface S3. The third lens L3 comprises a fifth surface S5 and a sixth surface S6 facing away from the fifth surface S5. The fourth lens L4 comprises a seventh surface S7 and an eighth surface S8 facing away from the seventh surface S7. The fifth lens L5 comprises a ninth surface S9 and a tenth surface S10 facing away from the ninth surface S9. The first surface S 1, the second surface 2, the third surface S3, the fourth surface S4, the fifth surface S5, the sixth surface S6, the seventh surface S7, the eighth surface S8, the ninth surface S9, and the tenth surface S10 are arranged in that sequence from object-side to image-side. Each of the first surface S1, the second surface S2, the third surface S3, the fourth surface S4, the fifth surface S5, the sixth surface S6, the seventh surface S7, the eighth surface S8, the ninth surface S9, and the tenth surface S10 is symmetric around the optical axis 101. Each of the first surface S1, the third surface S3, the fifth surface S5, the seventh surface S7, and the ninth surface S9 faces the object-side. Each of the second surface S2, the fourth surface S4, the sixth surface S6, the eighth surface S8, and the tenth surface S10 faces the image-side.

In at least one embodiment, the third surface S3 is a concave surface, the fourth surface S4 is a concave surface, the seventh surface S7 is a concave surface, the eighth surface S8 is a convex surface, which may help correct an astigmatism of the optical lens 100.

In at least one embodiment, the tenth surface S10 is a concave surface, which is beneficial for a principal point of the optical lens 100 to be far away from the image plane 30, and also may help to shorten the total optical length of the optical lens 100, thereby promoting a miniaturization of the optical lens 100. At least one of the ninth surface S9 and the tenth surface S10 has at least one point of inflection, which may effectively suppress an angle of incidence of the off-axis view field on an photosensitive element, and may further correct an optical aberration of the off-axis view field.

Each of the first surface S1, the second surface S2, the third surface S3, the fourth surface S4, the fifth surface S5, the sixth surface S6, the seventh surface S7, the eighth surface S8, the ninth surface S9, and the tenth surface S10 is an aspherical surface.

In at least one embodiment, the optical lens 100 satisfies a first combination including the following conditions (1), (2), (3), and (4), or satisfies a second combination including the following conditions (5), (6) and (7).

The first combination includes the following conditions (1), (2), (3), and (4):

−5.0≤(R3+R4)/(R3−R4)≤−0.75 (1)

−5.0≤(R5+R6)/(R5−R6)≤−0.8 (2)

−5.3≤R7/R8≤7 (3)

2≤(T2+T3)/T4≤4 (4)

Wherein, R3 denotes a radius of curvature of the third surface S3. R4 denotes a radius of curvature of the fourth surface S4. R5 denotes a radius of curvature of the fifth surface S5. R6 denotes a radius of curvature of the sixth surface S6. R7 denotes a radius of curvature of the seventh surface S7. R8 denotes a radius of curvature of the eighth surface S8. T2 denotes a distance from the fourth surface S4 to the image plane 30 along the optical axis 101. T3 denotes a distance from the sixth surface S6 to the image plane 30 along the optical axis 101. T4 denotes a distance from the eighth surface S8 to the image plane 30 along the optical axis 101.

The condition (1) may correct the optical aberration of the second lens L2, the condition (2) may correct the optical aberration of the third lens L3, and the condition (3) may correct the optical aberration of the fourth lens L4. Since the optical lens 100 satisfies the conditions (1), (2) and (3), the optical aberration of the optical lens 100 may be effectively reduced.

Since the optical lens 100 satisfies the condition (4), the miniaturization of the optical lens 100 may be promoted.

The second combination includes the following conditions (5), (6) and (7):

−5.0≤(R3+R4)/(R3−R4)≤−0.75 (5)

−5.0≤(R5+R6)/(R5−R6)≤−0.8 (6)

0.70≤EPD/TTL≤1.0 (7)

Wherein, EPD denotes an entrance pupil diameter of the optical lens 100. TTL denotes a distance from the first surface 51 to the image plane 30 along the optical axis 101.

Since the optical lens 100 satisfies the above conditions (5), (6) and (7), an amount of light getting into the optical lens 100 may be increased, the miniaturization of the optical lens 100 may be promoted.

In at least one embodiment, the optical lens 100 further satisfies the following condition (la):

−5.0≤(R3+R4)/(R3−R4)≤−1 (la)

In at least one embodiment, when the optical lens 100 satisfies the first combination, the optical lens 100 further satisfies the following condition (8):

2.5 mm<T1<4.0 mm. (8)

Wherein, T1 denotes a distance from the second surface S2 to the image plane 30 along the optical axis 101.

In at least one embodiment, when the optical lens 100 satisfies the first combination, the optical lens 100 further satisfies the following condition (9):

0.5 mm<T5<1.2 mm. (9)

Wherein, T5 denotes a distance from the tenth surface S10 to the image plane 30 along the optical axis 101.

Since the optical lens 100 satisfies at least one of the above conditions (8) and (9), the miniaturization of the optical lens 100 may be promoted.

In at least one embodiment, the optical lens 100 further satisfies the following conditions (10) and (11):

−1.1<(V1−V3)/V4<0 (10)

2.1<V4/V3<3 (6)

Wherein, V1 denotes a dispersion coefficient of the first lens L1. V3 denotes a dispersion coefficient of the third lens L3. V4 denotes a dispersion coefficient of the fourth lens L4.

Different refractive index materials have different dispersion coefficients. The refractive index is higher, the dispersion coefficient is lower. A chromatic dispersion range is smaller, the image of the optical lens 100 is better.

The aspherical surface can satisfy the following formula:

$$Z = \frac{c {r}^{2}}{1 + \sqrt{1 - ( 1 + K ) {c}^{2} {r}^{2}}} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{{ }^{16}} {h}^{16} + {A}_{18} {h}^{18} + {A}_{20} {h}^{20} + {A}_{22} {h}^{22}$$

Of the formula, Z denotes an aspherical surface sag of each surface; c denotes a reciprocal of radius of curvature; r denotes a radial distance of the surface from the optical axis; K denotes a conic constant; A4, A6, A8, A10, A12, A14, A16, A18, A20, and A22 denote a fourth aspherical coefficient, a sixth aspherical coefficient, a eighth aspherical coefficient, a tenth aspherical coefficient, a twelfth aspherical coefficient, a fourteenth aspherical coefficient, a sixteenth aspherical coefficient, a eighteenth aspherical coefficient, a twentieth aspherical coefficient, and a twenty-second aspherical coefficient, respectively.

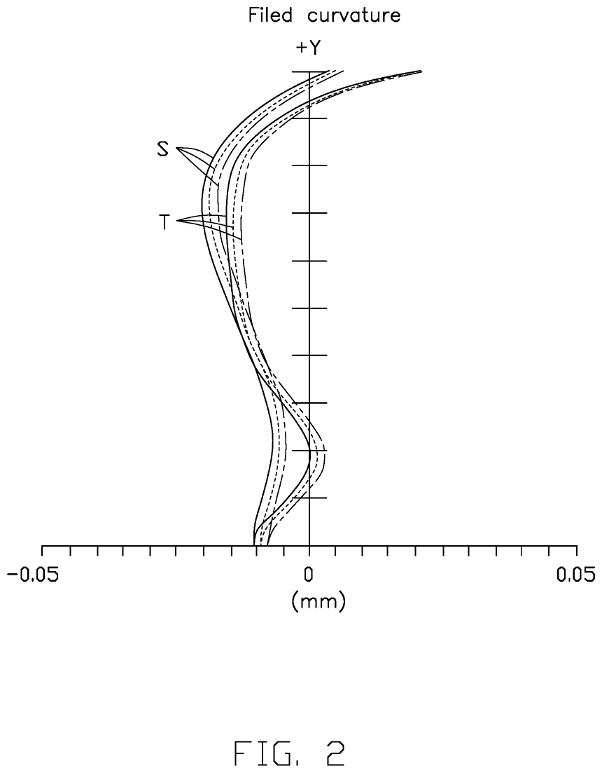

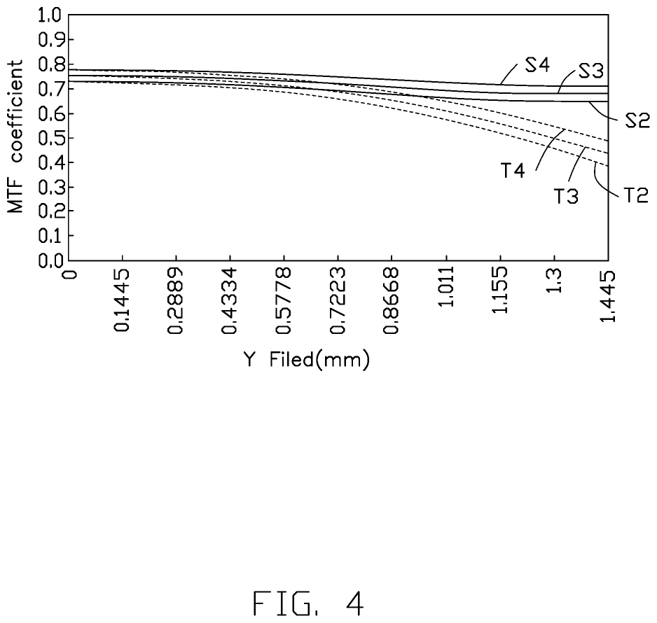

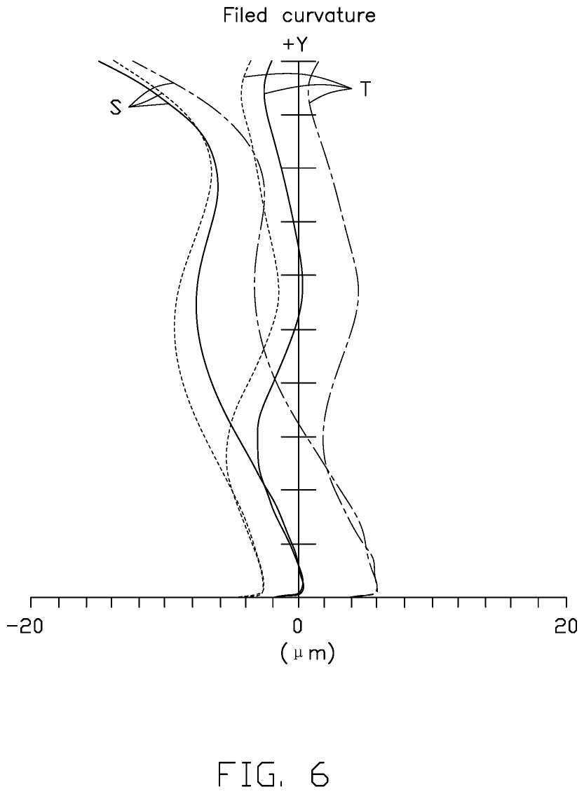

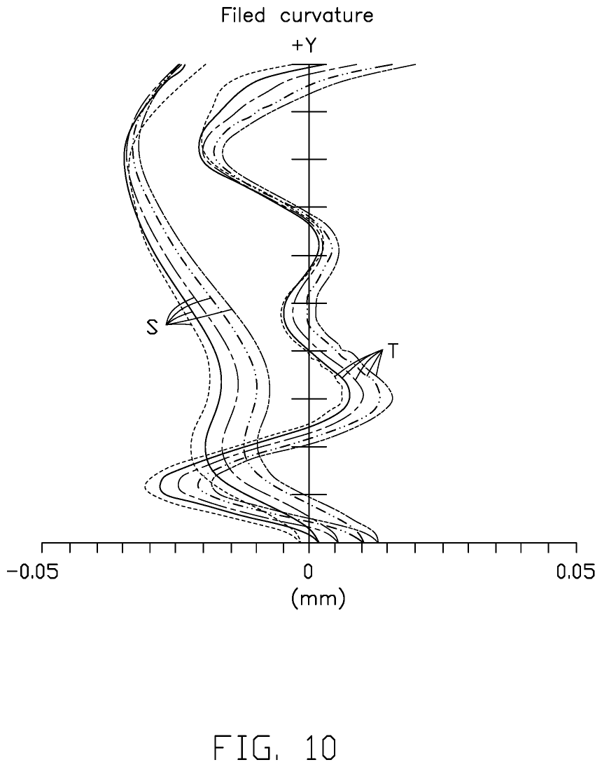

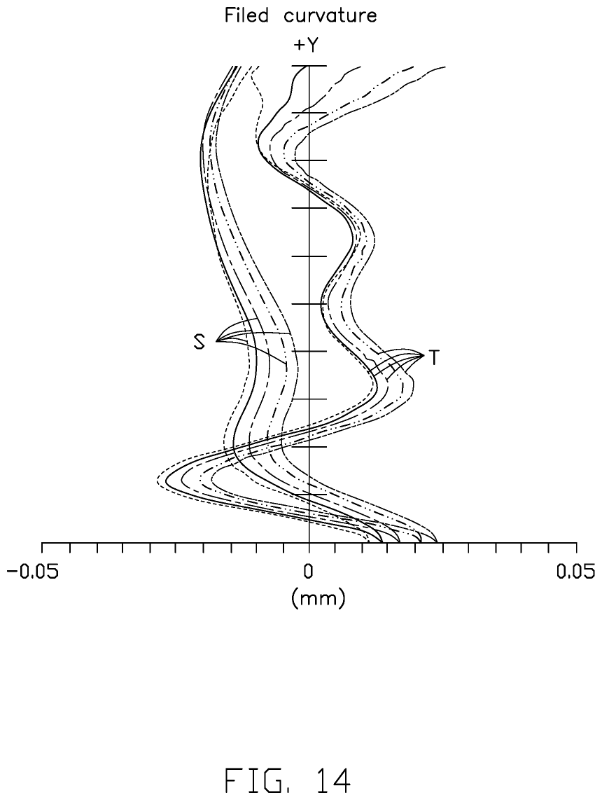

In the following examples, L denotes a distance between two adjacent surfaces along the optical axis 101; N denotes a refractive index of each lens; vd denotes an Abbe number of each lens. Referring to FIGS. 2, 6, 10, and 14, T denotes a tangential field curvature curve and S denotes a sagittal field curvature curve. Referring to FIGS. 4, 8, 12, and 16, T1, T2, and T3 respectively denote transfer function curves of the tangential direction at three different frequencies, S2, S3, and S4 respectively denote transfer function curves of the sagittal direction at three different frequencies.

### Example 1

FIG. 1 illustrates the optical lens 100 of the example 1. Tables 1-3 list the parameters of the optical lens 100 of the example 1.

TABLE 1

| | Aspherical coefficient | | | | | | | |
|---|---|---|---|---|---|---|---|---|
| surface | A2 | A4 | A6 | A8 | A10 | A12 | A14 | A16 |
| S1 | 0 | −0.197 | −1.398 | 29.062 | −161.585 | −504.744 | 6857.944 | −1.60E+04 |
| S2 | 0 | −0.976 | −0.332 | 1.069 | −14.655 | 12.349 | 99.523 | −333.929 |
| S3 | 0 | −0.59 | −2.167 | −1.008 | −10.079 | 25.874 | 20.165 | −301.033 |
| S4 | 0 | 0.097 | −1.276 | 0.868 | 4.302 | −6.324 | −32.245 | 48.048 |
| S5 | 0 | −0.419 | 0.871 | 1.246 | −3.728 | −5.569 | 7.886 | −0.141 |
| S6 | 0 | −0.447 | 0.283 | 1.034 | 0.637 | −1.941 | −3.645 | 2.805 |
| S7 | 0 | −0.58 | 0.914 | 1.352 | −0.731 | −2.972 | −0.16 | 2.029 |
| S8 | 0 | −0.692 | 0.86 | −0.493 | −0.188 | 0.227 | 0.57 | −0.28 |
| S9 | 0 | −0.882 | 0.841 | −0.553 | −0.31 | 0.03 | 0.775 | −0.599 |
| S10 | 0 | −0.399 | 0.494 | −0.515 | 0.292 | −0.056 | −0.02 | 8.67E−03 |

TABLE 2

| surface | c(mm) | L(mm) | N | vd | h(mm) | k |
|---|---|---|---|---|---|---|
| Object-side | infinity | 600 | | | 508.307 | 0 |
| Aperture | infinity | −0.033 | | | 0.416 | 0 |
| S1 | 2.228 | 0.316 | 1.54 | 56.0 | 0.48 | 6.756 |
| S2 | 1.707 | 0.05 | — | — | 0.53 | −53.722 |
| S3 | 0.946 | 0.25 | 1.66 | 20.4 | 0.54 | −11.938 |
| S4 | 1.016 | 0.071 | — | — | 0.7 | −10.323 |
| S5 | 1.842 | 0.315 | 1.66 | 20.4 | 0.72 | −20.527 |
| S6 | −24.004 | 0.1 | — | — | 0.815 | −4.33E+04 |
| S7 | −1.34 | 0.59 | 1.54 | 56.0 | 0.83 | −19.113 |
| S8 | −0.508 | 0.063 | — | — | 0.875 | −3.227 |
| S9 | 1.199 | 0.3 | 1.53 | 55.6 | 0.91 | −1.521 |
| S10 | 0.445 | 0.5 | — | — | 1.18 | −3.851 |
| optical filter | infinity | 0.15 | 1.52 | 64.2 | 1.445 | 6.756 |
| image plane | — | — | — | — | 1.445 | 0 |

TABLE 3

| Parameters | Value | |
|---|---|---|
| Maximum imaging height (Imgh) | 1.4446 | mm |
| The distance from the second surface S2 to the image | 2.589 | mm |
| plane along the optical axis (T1) | | |
| The distance from the fourth surface S4 to the image | 2.289 | mm |
| plane along the optical axis (T2) | | |
| The distance from the sixth surface S6 to the image | 1.903 | mm |
| plane along the optical axis (T3) | | |
| The distance from the eighth surface S8 to the image | 1.213 | mm |
| plane along the optical axis (T4) | | |
| The distance from the tenth surface S102 to the image | 0.85 | mm |
| plane along the optical axis (T5) | | |
| The dispersion coefficient of the first lens (V1) | 55.97818 | |
| The dispersion coefficient of the second lens (V2) | 20.3729 | |
| The dispersion coefficient of the third lens (V3) | 20.3729 | |
| The dispersion coefficient of the fourth lens (V4) | 55.97818 | |
| The dispersion coefficient of the fifth lens (V5) | 55.58355 | |
| The entrance pupil diameter of the optical lens (EPD) | 0.832 | mm |
| The total force length of the optical lens (f) | 1.69809 | mm |

The tangential field curvature and the sagittal field curvature of the optical lens 100 of the example 1 are kept within a range of −0.05 mm to 0.05 mm, respectively.

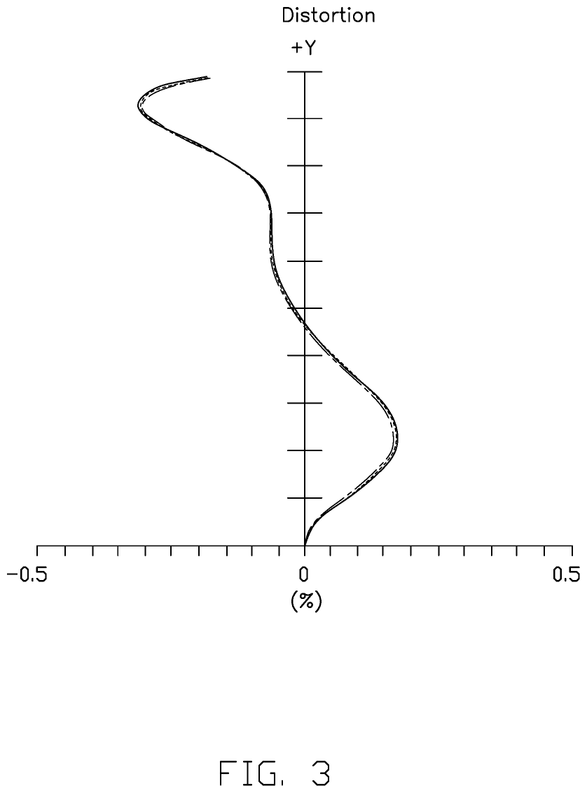

A distortion diagram of the optical lens 100 of the example 1 is shown in FIG. 3. The distortion of the optical lens 100 of the example 1 is kept within a range of −5.00% to 5.00%.

An optical-modulation transfer function diagram of the optical lens 100 of the example 1 is shown in FIG. 4. The abscissa, from left to right, represents a radius of a position on the imaging plane from a center of the imaging plane to an edge of the position. The leftmost is zero, which is the center of the optical lens 100. The rightmost is an edge of a radius of the image field. The optical-modulation transfer function curve is straighter, the image formation of the optical lens 100 is more uniform. The modulation transfer functions of the tangential direction and the sagittal direction at three different frequencies is greater than 0.45, which means that the optical lens 100 has a better resolution.

### Example 2

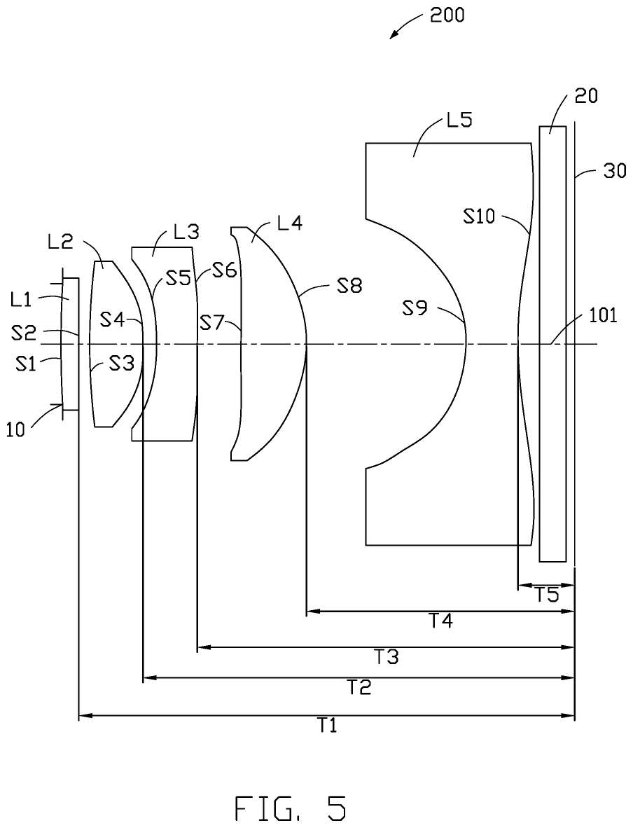

FIG. 5 illustrates the optical lens 200 of the example 2. Tables 4-6 list the parameters of the optical lens 200 of the example 2.

TABLE 4

Aspherical coefficient

| surface | A2 | A4 | A6 | A8 |
|---|---|---|---|---|
| S1 | 0 | −0.148 | −0.136 | 0.194 |
| S2 | 0 | −0.071 | −0.041 | 0.262 |
| S3 | 0 | 0.113 | 0.029 | −0.059 |
| S4 | 0 | −0.062 | −0.1 | 0.039 |
| S5 | 0 | −0.149 | 0.037 | 0.107 |
| S6 | 0 | −0.113 | 0.06 | 3.86E−03 |
| S7 | 0 | 7.62E−03 | −0.024 | −9.35E−03 |
| S8 | 0 | 0.055 | −9.28E−04 | −0.012 |
| S9 | 0 | −0.137 | 8.14E−04 | −5.74E−03 |
| S10 | 0 | −0.033 | 4.99E−03 | −4.38E−04 |

TABLE 5

| surface | c(mm) | L(mm) | N | vd | h(mm) | k |
|---|---|---|---|---|---|---|
| Object-side | infinity | infinity | | | infinity | 0 |
| Aperture | infinity | −0.033 | | | 0.416 | 0 |
| S1 | 3.908 | 0.138 | 1.54 | 56.0 | 0.635 | −14.177 |
| S2 | 15.024 | 0.104 | — | — | 0.682 | −3.92E+13 |
| S3 | 11.691 | 0.438 | 1.49 | 70.4 | 0.805 | −2.30E+13 |
| S4 | −1.794 | 0.105 | — | — | 0.851 | −0.465 |
| S5 | −3.007 | 0.334 | 1.76 | 27.6 | 0.88 | 6.142 |
| S6 | −22.183 | 0.357 | — | — | 1.006 | −8.65E+12 |
| S7 | −18.477 | 0.539 | 1.54 | 56.0 | 1.154 | −2.16E+13 |
| S8 | −1.73 | 1.321 | — | — | 1.21 | 0.469 |
| S9 | −1.634 | 0.421 | 1.55 | 45.9 | 1.308 | −4.322 |
| S10 | 4.08 | 0.191 | — | — | 2.085 | −3.105 |
| optical filter | infinity | 0.203 | — | — | 2.164 | 0 |
| image plane | infinity | — | — | — | 2.302 | 0 |

TABLE 6

| Parameters | Value | |
|---|---|---|
| Maximum imaging height (Imgh) | 2.3 | mm |
| The distance from the second surface S2 to the image | 3.948 | mm |
| plane along the optical axis (T1) | | |
| The distance from the fourth surface S4 to the image | 3.706 | mm |
| plane along the optical axis (T2) | | |
| The distance from the sixth surface S6 to the image | 3.163 | mm |
| plane along the optical axis (T3) | | |
| The distance from the eighth surface S8 to the image | 2.472 | mm |
| plane along the optical axis (T4) | | |
| The distance from the tenth surface S102 to the image | 0.612 | mm |
| plane along the optical axis (T5) | | |
| The dispersion coefficient of the first lens (V1) | 56 | |
| The dispersion coefficient of the second lens (V2) | 70.4 | |
| The dispersion coefficient of the third lens (V3) | 27.6 | |
| The dispersion coefficient of the fourth lens (V4) | 56 | |
| The dispersion coefficient of the fifth lens (V5) | 45.9 | |
| The entrance pupil diameter of the optical lens (EPD) | 1.27 | mm |
| The total force length of the optical lens (f) | 2.98 | mm |

The tangential field curvature and the sagittal field curvature of the optical lens 200 of the example 2 are kept within a range of −0.20 mm to 0.20 mm, respectively.

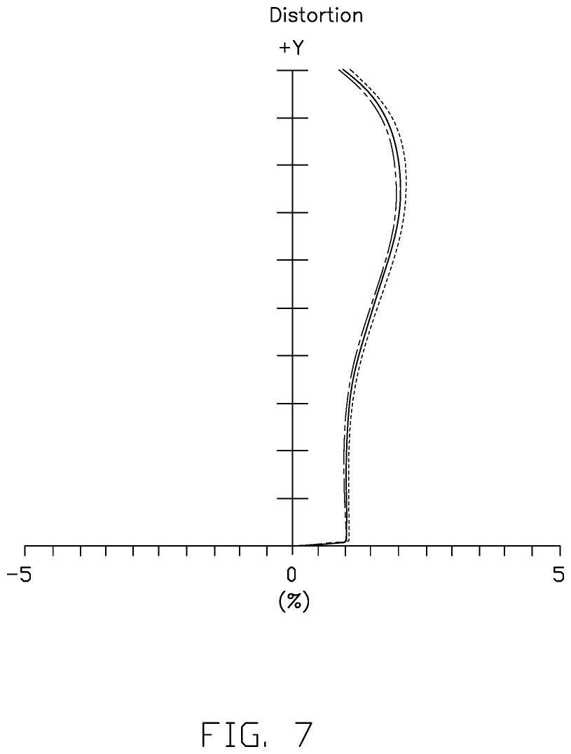

A distortion diagram of the optical lens 200 of the example 2 is shown in FIG. 7. The distortion of the optical lens 200 of the example 2 is kept within a range of −3.00% to 3.00%.

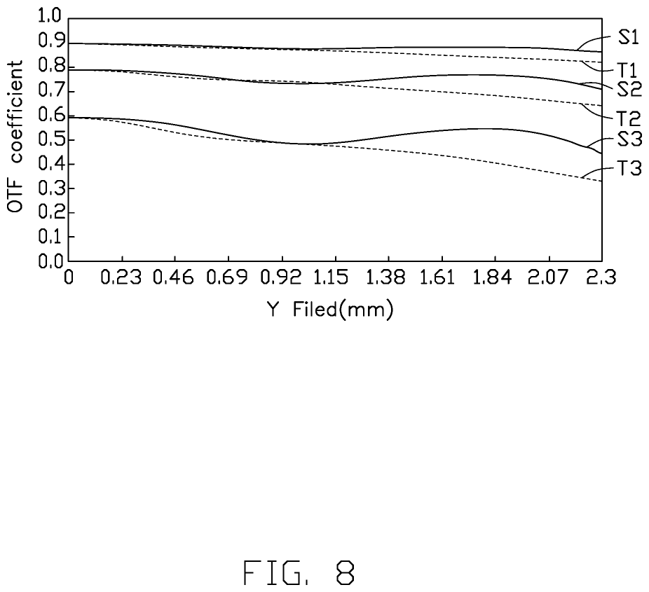

An optical-modulation transfer function diagram of the optical lens 200 of the example 2 is shown in FIG. 8. The abscissa, from left to right, represents a radius of a position on the imaging plane from a center of the imaging plane to an edge of the position. The leftmost is zero, which is the center of the optical lens 200. The rightmost is an edge of a radius of the image field. The optical-modulation transfer function curve is straighter, the image formation of the optical lens 200 is more uniform. The modulation transfer functions of the tangential direction and the sagittal direction at three different frequencies is greater than 0.40, which means that the optical lens 200 has a better resolution.

### Example 3

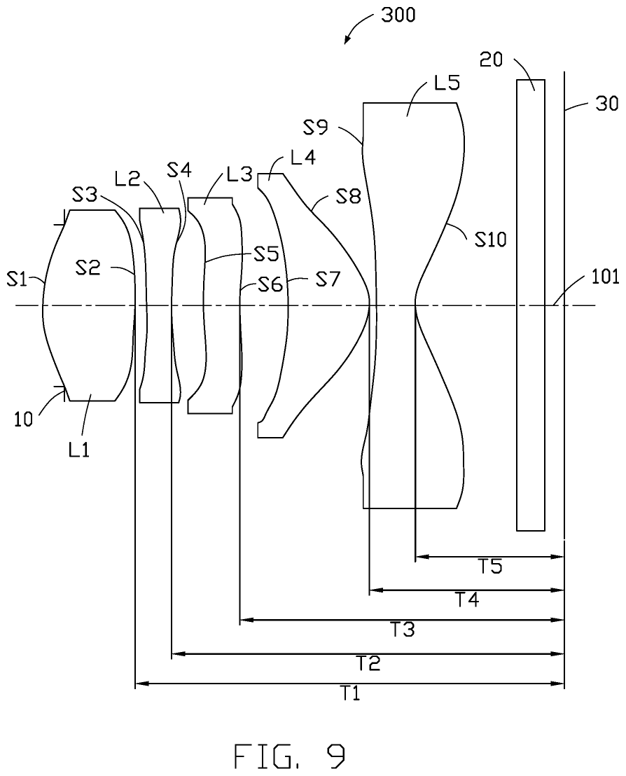

FIG. 9 illustrates the optical lens 300 of the example 3. Tables 7-9 list the parameters of the optical lens 300 of the example 3.

TABLE 7

| | Aspherical coefficient | | | | | | | |
|---|---|---|---|---|---|---|---|---|
| surface | A2 | A4 | A6 | A8 | A10 | A12 | A14 | A16 |
| S1 | 0 | −0.048 | −8.20E−03 | −0.067 | 5.37E−03 | 0.017 | −0.054 | 0 |
| S2 | 0 | −0.051 | −0.14 | 0.069 | 0.034 | −0.045 | 0.013 | 0 |
| S3 | 0 | 5.18E−03 | −0.076 | −0.07 | 0.162 | 0.026 | −0.07 | 0 |
| S4 | 0 | 0.099 | −0.09 | −0.015 | 0.025 | 4.86E−04 | −0.05 | 0 |
| S5 | 0 | −0.171 | 0.012 | −0.121 | −0.064 | 0.039 | 0.035 | 0 |
| S6 | 0 | −0.149 | 0.04 | −0.064 | −0.041 | 0.016 | 0.048 | 0 |
| S7 | 0 | −0.58 | 0.914 | 1.352 | −0.731 | −2.972 | −0.16 | 0 |
| S8 | 0 | −0.692 | 0.86 | −0.493 | −0.188 | 0.227 | 0.57 | 0 |
| S9 | 0 | −0.882 | 0.841 | −0.553 | −0.31 | 0.03 | 0.775 | 0 |
| S10 | 0 | −0.399 | 0.494 | −0.515 | 0.292 | −0.056 | −0.02 | 0 |

TABLE 8

| surface | c(mm) | L(mm) | N | vd | h(mm) | k |
|---|---|---|---|---|---|---|
| Object-side | infinity | 1000 | | | 758.979 | 0 |
| Aperture | infinity | −0.165 | | | 0.797 | 0 |
| S1 | 1.745 | 0.719 | 1.54 | 56.0 | 0.94 | 0.797 |
| S2 | −11.993 | 0.092 | — | — | 0.94 | 156.62 |
| S3 | −11.785 | 0.2 | 1.66 | 20.4 | 0.931 | −69.138 |
| S4 | 4.866 | 0.255 | — | — | 0.956 | −77.01 |
| S5 | 4.228 | 0.285 | 1.66 | 20.4 | 0.949 | −32.393 |
| S6 | 4.465 | 0.375 | — | — | 1.065 | −24.599 |
| S7 | −7.357 | 0.64 | 1.54 | 56.0 | 1.165 | 0.148 |
| S8 | −0.576 | 0.05 | — | — | 1.3 | −3.99E+00 |
| S9 | −249.719 | 0.317 | 1.53 | 55.6 | 1.671 | −1.38E+04 |
| S10 | 0.569 | 0.805 | — | — | 2 | −6.033 |
| optical filter | infinity | 0.21 | 1.52 | 64.2 | 2.165 | 0 |
| image plane | infinity | — | — | — | 2.298 | 0 |

TABLE 9

| Parameters | Value | |
|---|---|---|
| Maximum imaging height (Imgh) | 2.297 | mm |
| The distance from the second surface S2 to the image | 3.379 | mm |
| plane along the optical axis (T1) | | |
| The distance from the fourth surface S4 to the image | 3.087 | mm |
| plane along the optical axis (T2) | | |
| The distance from the sixth surface S6 to the image | 2.547 | mm |
| plane along the optical axis (T3) | | |
| The distance from the eighth surface S8 to the image | 1.532 | mm |
| plane along the optical axis (T4) | | |
| The distance from the tenth surface S102 to the image | 1.165 | mm |
| plane along the optical axis (T5) | | |
| The dispersion coefficient of the first lens (V1) | 55.97818 | |
| The dispersion coefficient of the second lens (V2) | 20.3729 | |
| The dispersion coefficient of the third lens (V3) | 20.3729 | |
| The dispersion coefficient of the fourth lens (V4) | 55.97818 | |
| The dispersion coefficient of the fifth lens (V5) | 55.583549 | |
| The entrance pupil diameter of the optical lens (EPD) | 1.594 | mm |
| The total force length of the optical lens (f) | 3.02188 | mm |

The tangential field curvature and the sagittal field curvature of the optical lens 300 of the example 3 are kept within a range of −0.20 mm to 0.20 mm, respectively.

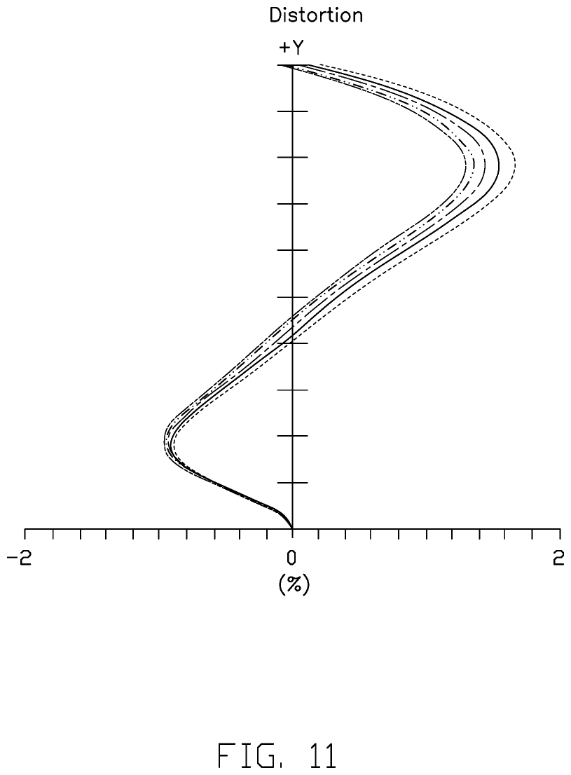

A distortion diagram of the optical lens 300 of the example 3 is shown in FIG. 11. The distortion of the optical lens 300 of the example 3 is kept within a range of −3.00% to 3.00%.

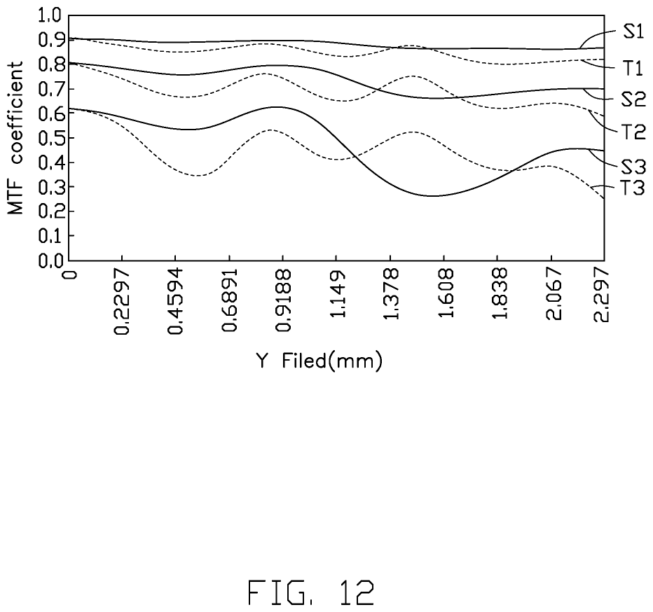

An optical-modulation transfer function diagram of the optical lens 300 of the example 3 is shown in FIG. 12. The abscissa, from left to right, represents a radius of a position on the imaging plane from a center of the imaging plane to an edge of the position. The leftmost is zero, which is the center of the optical lens 300. The rightmost is an edge of a radius of the image field. The optical-modulation transfer function curve is straighter, the image formation of the optical lens 300 is more uniform. The modulation transfer functions of the tangential direction and the sagittal direction at three different frequencies is greater than 0.30, which means that the optical lens 300 has a better resolution.

### Example 4

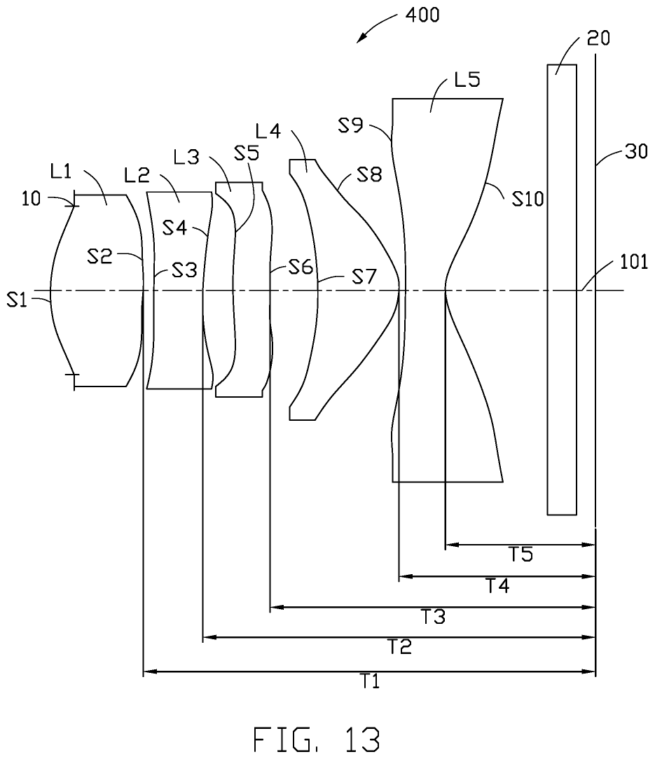

FIG. 13 illustrates the optical lens 400 of the example 4. Tables 10-12 list the parameters of the optical lens 400 of the example 4.

TABLE 10

| | Aspherical coefficient | | | | | | |
|---|---|---|---|---|---|---|---|
| surface | A2 | A4 | A6 | A8 | A10 | A12 | A14 |
| S1 | 0 | −0.045 | −0.013 | −0.066 | 0.014 | 0.026 | −0.065 |
| S2 | 0 | −0.037 | −0.144 | 0.057 | 0.027 | −0.037 | 0.019 |
| S3 | 0 | 3.98E−03 | −0.074 | −0.074 | 0.142 | 0.018 | −0.05 |
| S4 | 0 | 0.096 | −0.087 | −0.011 | 0.024 | −3.74E−03 | −0.059 |
| S5 | 0 | −0.171 | 0.012 | −0.121 | −0.064 | 0.039 | 0.035 |
| S6 | 0 | −0.149 | 0.04 | −0.064 | −0.041 | 0.016 | 0.048 |
| S7 | 0 | −0.136 | 0.074 | 6.68E+00 | 0.018 | −0.037 | −0.032 |
| S8 | 0 | −0.183 | 0.077 | 0.021 | 1.70E−03 | 1.10E−03 | −1.79E−03 |
| S9 | 0 | −0.055 | 0.02 | 1.16E−03 | −1.54E−04 | −1.65E−04 | −2.55E−05 |
| S10 | 0 | −0.072 | 0.037 | −0.014 | 3.22E−03 | −2.46E−04 | −4.05E−05 |

TABLE 11

| surface | c(mm) | L(mm) | N | vd | h(mm) | k |
|---|---|---|---|---|---|---|
| Object-side | infinity | 1000 | | | 683.844 | 0 |
| Aperture | infinity | −0.165 | | | 0.825 | 0 |
| S1 | 1.747 | 0.719 | 1.54 | 56.0 | 0.84 | 0.839 |
| S2 | −12.443 | 0.092 | — | — | 0.93 | 166.199 |
| S3 | −13.768 | 0.381 | 1.66 | 20.4 | 0.93 | −26.83 |
| S4 | 4.345 | 0.235 | — | — | 0.959 | −64.372 |
| S5 | 4.228 | 0.285 | 1.66 | 20.4 | 0.951 | −32.393 |
| S6 | 4.465 | 0.375 | — | — | 1.044 | −2.46E+01 |
| S7 | −7.357 | 0.54 | 1.54 | 56.0 | 1.151 | 0.148 |
| S8 | −0.576 | 0.05 | — | — | 1.268 | −3.993 |
| S9 | −19.884 | 0.317 | 1.53 | 55.6 | 1.614 | −183.666 |
| S10 | 0.571 | 0.811 | — | — | 1.874 | −6.199 |
| optical filter | infinity | 0.21 | — | — | 2.115 | 0 |
| image plane | infinity | — | — | — | 2.307 | 0 |

TABLE 12

| Parameters | Value | |
|---|---|---|
| Maximum imaging height (Imgh) | 2.297 | mm |
| The distance from the second surface S2 to the image | 3.545 | mm |
| plane along the optical axis (T1) | | |
| The distance from the fourth surface S4 to the image | 3.072 | mm |
| plane along the optical axis (T2) | | |
| The distance from the sixth surface S6 to the image | 2.553 | mm |
| plane along the optical axis (T3) | | |
| The distance from the eighth surface S8 to the image | 1.538 | mm |
| plane along the optical axis (T4) | | |
| The distance from the tenth surface S102 to the image | 1.171 | mm |
| plane along the optical axis (T5) | | |
| The dispersion coefficient of the first lens (V1) | 55.97818 | |
| The dispersion coefficient of the second lens (V2) | 20.3729 | |
| The dispersion coefficient of the third lens (V3) | 20.3729 | |
| The dispersion coefficient of the fourth lens (V4) | 55.97818 | |
| The dispersion coefficient of the fifth lens (V5) | 55.583549 | |
| The entrance pupil diameter of the optical lens (EPD) | 1.65 | mm |
| The total force length of the optical lens (f) | 3.222 | mm |

The tangential field curvature and the sagittal field curvature of the optical lens 400 of the example 4 are kept within a range of −0.20 mm to 0.20 mm, respectively.

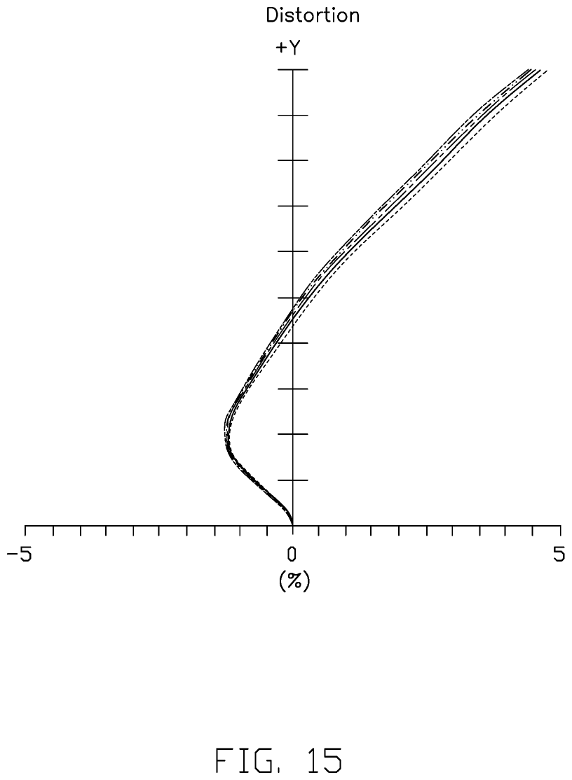

A distortion diagram of the optical lens 400 of the example 4 is shown in FIG. 15. The distortion of the optical lens 400 of the example 4 is kept within a range of −3.00% to 3.00%.

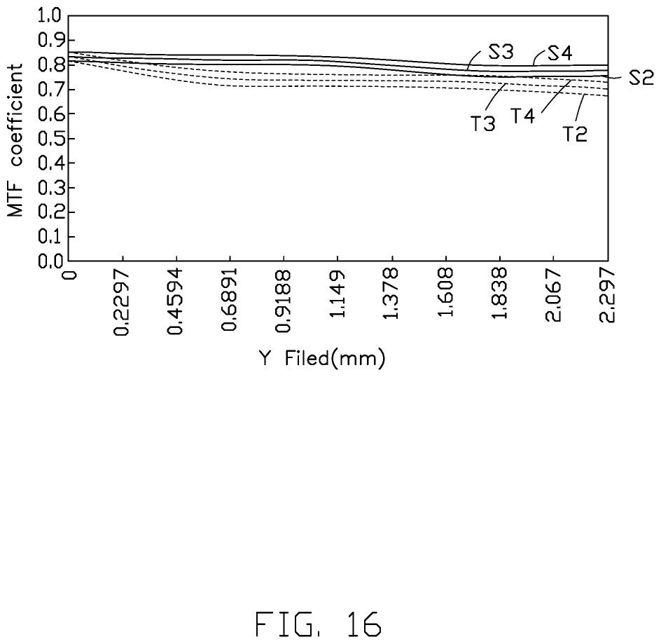

An optical-modulation transfer function diagram of the optical lens 400 of the example 4 is shown in FIG. 16. The abscissa, from left to right, represents a radius of a position on the imaging plane from a center of the imaging plane to an edge of the position. The leftmost is zero, which is the center of the optical lens 400. The rightmost is an edge of a radius of the image field. The optical-modulation transfer function curve is straighter, the image formation of the optical lens 400 is more uniform. The modulation transfer functions of the tangential direction and the sagittal direction at three different frequencies is greater than 0.70, which means that the optical lens 400 has a better resolution.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. An optical lens having an optical axis, the optical lens comprising:
an aperture;
a first lens comprising a first surface facing object-side and a second surface facing away from the first surface;
a second lens comprising a third surface facing object-side and a fourth surface facing away from the third surface;
a third lens having comprising a fifth surface facing object-side and a sixth surface facing away from the fifth surface;
a fourth lens comprising a seventh surface facing object-side and an eighth surface facing away from the seventh surface;
a fifth lens comprising a ninth surface facing object-side and a tenth surface facing away from the ninth surface; and
an image plane;
wherein the aperture, the first lens, the second lens, the third lens, the fourth lens, the fifth lens, and the image plane are arranged in that sequence from object-side to image-side along the optical axis; the first surface, the second surface, the third surface, the fourth surface, the fifth surface, the sixth surface, the seventh surface, the eighth surface, the ninth surface, and the tenth surface are arranged in that sequence from object-side to image-side; the optical lens satisfies a first combination or a second combination, the first combination comprises the following conditions:
−5.0≤(R3+R4)/(R3−R4)≤−0.75;
−5.0≤(R5+R6)/(R5−R6)≤−0.8;
−5.3≤R7/R8≤7; and
2≤(T2+T3)/T4≤4;
wherein R3 denotes a radius of curvature of the third surface, R4 denotes a radius of curvature of the fourth surface, R5 denotes a radius of curvature of the fifth surface, R6 denotes a radius of curvature of the sixth surface, R7 denotes a radius of curvature of the seventh surface, R8 denotes a radius of curvature of the eighth surface, T2 denotes a distance from the fourth surface to the image plane along the optical axis, T3 denotes a distance from the sixth surface to the image plane along the optical axis, T4 denotes a distance from the eighth surface to the image plane along the optical axis;
the second combination comprises the following conditions:
−5.0≤(R3+R4)/(R3−R4)≤−0.75;
−5.0≤(R5+R6)/(R5−R6)≤−0.8; and
0.70≤EPD/TTL≤1.0;
wherein EPD denotes an entrance pupil diameter of the optical lens, TTL denotes a distance from the first surface to the image plane along the optical axis.

2. The optical lens of claim 1, wherein the first lens has a positive refractive power, the second lens has a negative refractive power, the third lens has a negative refractive power, the fourth lens has a positive refractive power, and the fifth lens has a negative refractive power.

3. The optical lens of claim 2, wherein the optical lens further comprises an optical filter between the fifth lens and the image plane.

4. The optical lens of claim 3, wherein the optical lens further satisfies the following condition:
−5.0≤(R3+R4)/(R3−R4)≤−1.

5. The optical lens of claim 1, wherein the optical lens further satisfies the following condition:
2.5 mm<T1<4.0 mm.

6. The optical lens of claim 1, wherein the optical lens further satisfies the following condition:
0.5 mm<T5<1.2 mm.

7. The optical lens of claim 1, wherein the optical lens further satisfies the following condition:
−1.1<(V1−V3)/V4<0; and
2.1<V4/V3<3;
wherein V1 denotes a dispersion coefficient of the first lens, V3 denotes a dispersion coefficient of the third lens, V4 denotes a dispersion coefficient of the fourth lens.

8. The optical lens of claim 1, wherein each of the first surface, the second surface, the third surface, the fourth surface, the fifth surface, the sixth surface, the seventh surface, the eighth surface, the ninth surface, and the tenth surface is an aspherical surface.

9. The optical lens of claim 1, wherein the third surface is a concave surface, the fourth surface is a concave surface, the seventh surface is a concave surface, and the eighth surface is a convex surface.

10. The optical lens of claim 1, wherein the tenth surface is a concave surface, at least one of the ninth surface and the tenth surface has at least one point of inflection.
